(19) United States
(12) Patent Application Publication
(10) Pub. No.: US 2026/0088437 A1
(43) Pub. Date: Mar. 26, 2026

(54) SPACE-OPTIMIZING BATTERY STACK FOR POWER AND BATTERY BACKUP ENCLOSURES

(71) Applicant: VERTIV CORPORATION, Westerville, OH (US)

(72) Inventors: Jerome A. Maloney, Sugar Grove, IL (US); Paul G. Misar, Lombard, IL (US)

(21) Appl. No.: 19/324,941

(22) Filed: Sep. 10, 2025

Related U.S. Application Data
(60) Provisional application No. 63/698,892, filed on Sep. 25, 2024.

(51) Int. Cl. H01M 50/298; H01M 50/209; H01M 50/24; H01M 50/503; H01M 50/507; H01M 50/51; H01M 50/55

(52) U.S. Cl. CPC H01M 50/298; H01M 50/209; H01M 50/24; H01M 50/503; H01M 50/507; H01M 50/51; H01M 50/55

(57) ABSTRACT

A space-optimizing battery arrangement for an enclosure such as a power and battery backup outside plant (OSP) enclosure. In embodiments, the battery arrangement includes a stack of battery sets wherein each set is aligned in a vertical plane positioned forward of a vertical plane of the immediately below positioned battery set. Battery cables for at least some battery sets are routed downward and laterally in the space formed forward of the recessed battery set positioned immediately below. In some embodiments, the bottom battery set includes angled busbars for routing the battery cable straight and laterally to confine the routing to a small vertical space. In embodiments, the batteries are Li-Ion batteries and the battery arrangement permits the required number of batteries to avoid thermal shutdown while maximizing space available to position critical infrastructure equipment.

### CROSS REFERENCE TO RELATED APPLICATION

This application claims the benefit of priority of U.S. Provisional Application No. 63/698,892, filed Sep. 25, 2024, which is hereby incorporated by reference in its entirety.

### TECHNICAL FIELD

The present disclosure is directed generally to power and battery backup enclosures, and more particularly, to a spaced-optimizing battery stack for outside plant (OSP) enclosures.

### BACKGROUND

Enclosures such as power and battery backup OSP enclosures require interior space for installing both infrastructure equipment and batteries. Considering the interior space constraints of enclosures, trade-offs must be made between the number of batteries utilized (i.e., total battery backup time) and space allotted for the infrastructure equipment. The balance between the number of batteries and space allotted for infrastructure equipment is further complicated if the intended enclosure utilizes a direct air-cooling system and has a 50 deg C. maximum operating temperature requirement.

In the above-described scenario utilizing Li-Ion batteries, to maximize valuable battery backup time, it is necessary to use enough batteries to compensate for the electrical needs of the overall system such that premature thermal shutdown of the Li-Ion batteries does not occur (e.g., when their internal cores reach 60 deg C.) Thus, it is imperative that limitations are not put on the number of Li-Ion batteries utilized or limiting the deployment of any critical infrastructure equipment because of space needed to route the battery cables.

Therefore, what is needed is a battery arrangement in which battery cables are routed freely without interference from adjacent batteries within the equipment rack space, and in which cable routing can be confined in a smaller vertical space than a traditional 90 deg turn of the battery cable will allow.

### SUMMARY

According to one aspect, the present disclosure is directed to a battery arrangement for a power and battery backup enclosure delimiting an interior space. In embodiments, the battery arrangement includes a first battery set mounted in the interior space and including at least two batteries having positive and negative battery cable termination posts aligned along a first vertical plane, a first battery cable electrically coupled to the positive and negative battery cable termination posts of the at least two batteries of the first battery set, a second battery set mounted in the enclosure above the first battery set and including at least two batteries having positive and negative battery cable termination posts aligned along a second vertical plane positioned forward relative to the first vertical plane, and a second battery cable electrically coupled to the positive and negative battery cable termination posts of the at least two batteries of the second battery set.

In some embodiments, the positive and negative cable termination posts of the at least two batteries of the first battery set are positioned along a front of the interior space, the first battery cable is routed laterally toward one side of the interior space, the positive and negative battery cable termination posts of the at least two batteries of the second battery set are positioned along the front of the interior space, and the second battery cable is routed downward and then laterally toward the one side of the interior space.

In some embodiments, the first battery set further includes a first busbar coupled to the positive battery cable termination posts of the at least two batteries and a second busbar coupled to the negative battery cable termination posts of the at least two batteries, the first battery cable is electrically coupled to the first and second busbars of the first battery set, the second battery set further comprises a first busbar coupled to the positive battery cable termination posts of the at least two batteries and a second busbar coupled to the negative battery cable termination posts of the at least two batteries, and the second battery cable is electrically coupled to the first and second busbars of the second battery set.

In some embodiments, the first and second busbars of the first battery set are angled, and the first and second busbars of the second battery set are linear.

In some embodiments, for the first battery set, each of the first and second busbars includes a first portion and a second portion perpendicular to the first portion, and a length of the first portion of the first busbar is greater than a length of the first portion of the second busbar, or vice versa.

In some embodiments, the battery arrangement further includes a third battery set mounted in the enclosure above the second battery set, the third battery set including at least two batteries having positive and negative battery cable termination posts aligned along a third vertical plane positioned forward relative to the second vertical plane, and a third battery cable electrically coupled to the positive and negative battery cable termination posts of the at least two batteries of the third battery set, wherein the positive and negative battery cable termination posts of the at least two batteries of the third battery set are positioned along a front of the interior space, and the third battery cable is routed downward and then laterally toward one side of the interior space.

In some embodiments, the third battery set further includes a first busbar coupled to the positive battery cable termination posts of the at least two batteries and a second busbar coupled to the negative battery cable termination posts of the at least two batteries, the third battery cable is electrically coupled to the first and second busbars of the third battery set, and the first and second busbars of the third battery set are linear.

In some embodiments, the battery arrangement further includes a fourth battery set mounted in the enclosure above the third battery set, the fourth battery set including at least two batteries having positive and negative battery cable termination posts aligned along a fourth vertical plane positioned forward relative to the third vertical plane, and a fourth battery cable electrically coupled to the positive and negative battery cable termination posts of the at least two batteries of the fourth battery set, wherein the positive and negative battery cable termination posts of the at least two batteries of the fourth battery set are positioned along a front of the interior space, and the fourth battery cable is routed downward and then laterally toward one side of the interior space.

In some embodiments, the fourth battery set further includes a first busbar coupled to the positive battery cable termination posts of the at least two batteries and a second busbar coupled to the negative battery cable termination posts of the at least two batteries, the fourth battery cable is electrically coupled to the first and second busbars of the fourth battery set, and the first and second busbars of the fourth battery set are linear.

According to another aspect, the present disclosure is directed to an outside plant enclosure including a housing delimiting an interior space accessible through a front of the enclosure, the interior space including an upper portion for mounting electronic equipment and a lower portion. In embodiments, the enclosure includes a battery stack mounted in the lower portion of the interior space, and the battery stack includes a first battery set including at least two batteries having positive and negative battery cable termination posts aligned at the front of the enclosure along a first vertical plane, a first battery cable electrically coupled to the positive and negative battery cable termination posts of the at least two batteries of the first battery set, a second battery set mounted above the first battery set and including at least two batteries having positive and negative battery cable termination posts aligned at the front of the enclosure along a second vertical plane positioned forward relative to the first vertical plane, and a second battery cable electrically coupled to the positive and negative battery cable termination posts of the at least two batteries of the second battery set.

In some embodiments, the first battery cable is routed laterally toward one side of the interior space, and the second battery cable is routed downward and then laterally toward the one side of the interior space.

According to a further aspect, the present disclosure is directed to a battery stack configured to be mounted in an interior space delimited by an enclosure. In embodiments, the battery stack includes a first battery set including at least two batteries each having positive and negative battery cable termination posts aligned along a first vertical plane, a second battery set mounted above the first battery set and including at least two batteries each having positive and negative battery cable termination posts aligned along a second vertical plane positioned forward of the first vertical plane, at least one additional battery set mounted above the second battery set and including at least two batteries each having positive and negative battery cable termination posts aligned along a vertical plane positioned forward of the vertical plane of the respective battery set positioned immediately below, a first battery cable electrically connected to the positive and negative battery cable termination posts of the first battery set and routed laterally, a second battery cable electrically connected to the positive and negative battery cable termination posts of the second battery set and routed downward and then laterally, and at least one additional battery cable, each at least one additional battery cable electrically connected to one of the additional battery sets and routed downward and then laterally.

In some embodiments, the first battery set, the second battery set, and the at least one additional battery set are arranged in an inverse staircase pattern such that the first battery set is recessed relative to the second battery set, and the second battery set is recessed relative to the at least one additional battery set.

In some embodiments, each of the first battery cable, the second battery cable, and the at least one additional battery cable includes a disconnect connector.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the present disclosure disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a left front isometric view of an OSP enclosure, in accordance with an example embodiment of the present disclosure;

FIG. 2 is detailed view of FIG. 1 illustrating a first or bottom battery set and associated battery cable routing, in accordance with an example embodiment of the present disclosure;

FIG. 3 is a right front isometric view of the OSP enclosure shown with the right side of the enclosure removed for clarity of the battery stack, in accordance with an example embodiment of the present disclosure;

FIG. 4 is a detailed view of FIG. 3 illustrating the battery stack mounting in the OSP enclosure, in accordance with an example embodiment of the present disclosure;

FIG. 5 is a fragmentary side elevation view of the OSP enclosure shown with the right side of the enclosure removed for clarity of the battery stack, in accordance with an example embodiment of the present disclosure;

FIG. 6 is a right front isometric view of a batter set, in accordance with an example embodiment of the present disclosure;

FIG. 7 is a detailed view of FIG. 6 illustrating adjustable mounting ears associated with the batteries, in accordance with an example embodiment of the present disclosure;

FIG. 8 is a perspective view of a portion of a battery cable for use with the second and successive battery sets for downward and lateral battery cable routing, in accordance with an example embodiment of the present disclosure;

FIG. 9 is a perspective view of a portion of a battery cable for use with the first battery set for lateral battery cable routing, in accordance with an example embodiment of the present disclosure;

FIG. 10 is an isometric view of the angled positive and negative busbars for use with the first battery set for lateral battery cable routing, in accordance with an example embodiment of the present disclosure; and

FIG. 11 is left front fragmentary isometric view of the OSP enclosure illustrating covers for covering the positive and negative battery cable connections to the batteries, in accordance with an example embodiment of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly, the present disclosure is directed to power and battery backup enclosures and battery arrangements for enclosures such as outside plant (OSP) enclosures or, even more broadly, electronics cabinets. In embodiments, the present disclosure provides configurations and methodologies for organizing (e.g., stacking) a plurality of batteries within an enclosure to maximize the number of batteries included in the enclosure while avoiding thermal issues and while preserving maximal space within the enclosure for mounting infrastructure equipment such as computer, data, communication, etc. equipment. In embodiments, the batteries may be Li-Ion batteries (e.g., 180 Amp hour Li-Ion batteries) provided in sets including at least two batteries, wherein each battery set is positioned about a different vertical plane to provide spacing for routing battery cables.

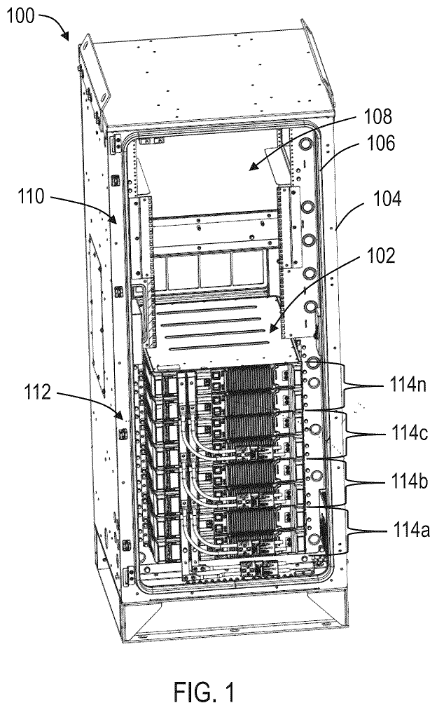

FIG. 1 illustrates a non-limiting example of an OSP enclosure 100 including a battery arrangement or stack 102 according to the present disclosure. The OSP enclosure 100 generally includes a housing 104 implemented as a cabinet having a top, a bottom, a left side, a right side, a back, and a front. As shown, the housing 104 forms a front opening 106 for accessing equipment and cabling mounted and positioned within the interior space 108 delimited by the housing 104. Although not shown, the OSP enclosure 100 may include a door configured to open and close to provide access to the interior space 108. Although not shown, the enclosure 100 may include air handling equipment such as at least one fan and filter for direct air-cooling applications, and power handling equipment such as a power distribution block.

The interior space 108 may be subdivided, physically or conceptually, into an upper portion 110 reserved for infrastructure equipment, and a lower portion 112 reserved for power and battery backup equipment such as the battery stack 102 and associated cabling. In a particular conceived example, the housing 104 may be dimensioned approximately 183 cm×81 cm×84 cm (e.g., 72 inches×32 inches×33 inches) to provide a standard 36 RU of equipment rack space, wherein approximately 17 RU is consumed to mount about 16 RU of battery mass and the remainder of the interior space is reserved to mount infrastructure equipment. While the battery stack 102 is shown mounted in the lower portion 112 leaving the upper portion 110 open for mounting infrastructure equipment, the battery stack 102 may be mounted in the upper portion 110 leaving open the lower portion 112 for mounting the infrastructure equipment, as well as alternative divisions of the interior space 108.

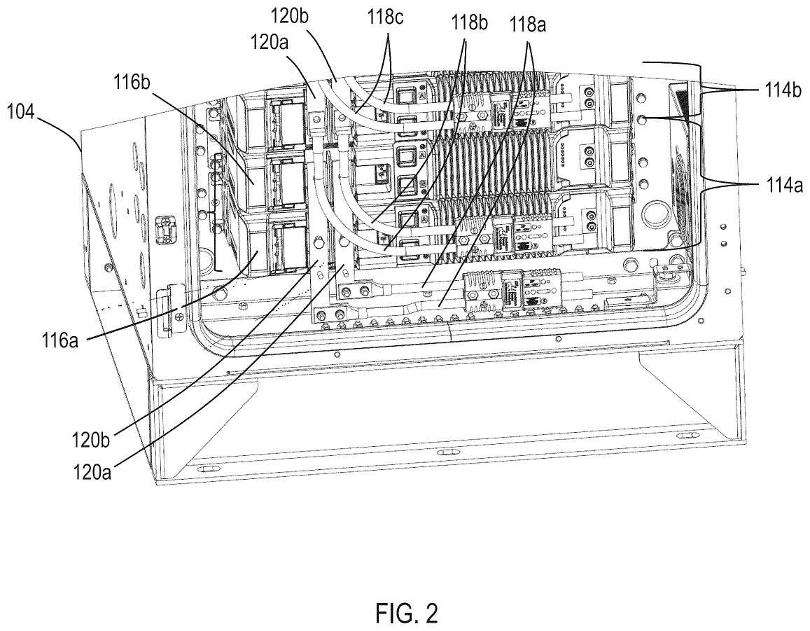

FIG. 2 illustrates part of the lower portion 112 of the interior space including part of the battery stack 102. As discussed in detail below, the battery stack 102 includes a first battery set 114a mounted in the interior space above the bottom of the housing 114. In embodiments, the first battery set 114a includes at least two batteries. As shown, the first battery set 114a includes two batteries 116a, 116b mounted one directly above the other. The two batteries 116a, 116b may be Li-Ion or other battery types mounted separately in the enclosure or together as a physically connected set. In embodiments, the bottom battery 116a is elevated above the bottom of the housing 104, for example about 8 cm to 12 cm, to accommodate a power distribution block positioned below the battery stack 102. In alternative embodiments, each battery set may include a single battery, two batteries, three batteries, or more than three batteries, and each battery set does not necessarily have to include the same number of batteries.

Each battery set includes a battery cable electrically coupled to positive and negative battery cable termination posts on the batteries. As shown in FIGS. 1 and 2, the batteries are configured and oriented relative to the housing 104 such that the positive and negative battery cable termination posts are presented at the front opening such that the associated battery cables are accessible and routed along the front opening. To maximize battery density and minimize the amount of interior space consumed by the battery stack 102, the first battery cable 118a associated with the first battery set 114a is routed differently than the second and additional battery cables 118b, 118c . . . 118n associated with the second and additional battery sets 114b, 114c . . . 114n positioned above the first battery set 114a. More specifically, the first battery cable 118a is routed laterally toward one lateral side of the interior space, whereas the second and additional battery cables 118b, 118c . . . 118n are routed downward and then laterally toward one lateral side of the interior space. As shown, each battery cable 118a, 118b, 118c is routed toward the same lateral side of the interior space where the battery cables are further routed alongside the battery stack 102 and ultimately routed to a power distribution block (not shown). The details of the cable routing downstream of the initial lateral routing are not critical to the present disclosure.

By routing the first battery cable 118a laterally, the vertical space needed for cable routing for the first battery set 114a is less than the vertical space needed to route the second and additional battery cables 118b, 118c . . . 118n first downward and then laterally, thus allowing the battery stack 102 to be positioned relatively low in the housing 104. In embodiments, the second and additional battery cables 118b, 118c . . . 118n may be routed vertically downward and then horizontally laterally such that the cable direction change is approximately 90 degrees. Each battery cable is connected to a busbar conductively coupled to the battery cable termination posts on the batteries. More specifically, a negative busbar 120a is conductively coupled to the negative battery cable termination posts on the respect battery set, and a separate positive busbar 120b is conductively coupled to the positive battery cable termination posts on the respective battery set. In this configuration, a single busbar can be used to conductively couple a single battery cable to all batteries within the same battery set, for example two batteries as shown.

As shown in FIG. 2, the positive and negative busbars 120a, 120b associated with the first battery set 114a are angled to facilitate routing the first battery cable 118a laterally, whereas the positive and negative busbars 120a, 120b associated with the second and additional battery sets 114b . . . 114n are linear to facilitate initial downward routing of the second and additional battery cables 118b, 118c . . . 118n. The configurations of the positive and negative busbars 120a, 120b for the first, second and additional battery sets 114a, 114b . . . 114n are discussed in detail below.

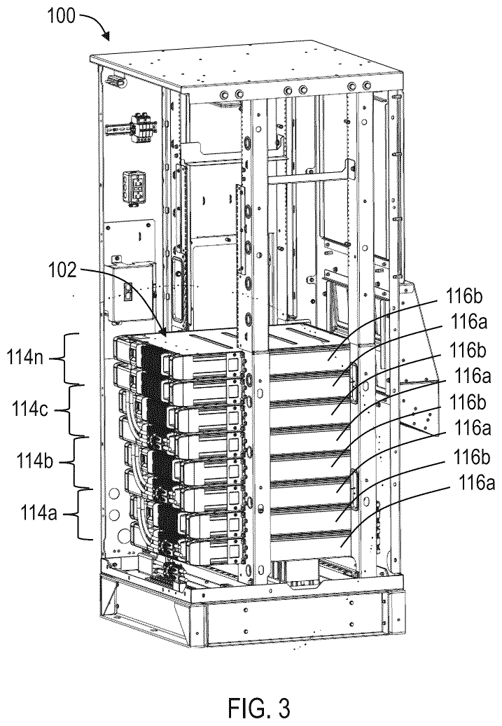

FIG. 3 illustrates the position of the battery stack 102 within the enclosure 100, and relative position of each battery set 114a, 114b, 114c, 114n. In a non-limiting example, the battery stack 102 includes four battery sets wherein the first battery set 114a is positioned at the bottom of the battery stack 102, the second battery set 114b is positioned directly above the first battery set 114a, the third battery set 114c is positioned directly above the second battery set 114b, and the fourth battery set 114n is positioned directly above the third battery set 114c. Each battery set shown includes a first battery 116a and a second battery 116b which are aligned as discussed below. In embodiments, each battery 116a, 116b is spaced apart from the housing walls to facilitate airflow within the interior space, for instance by an air gap of approximately 5 mm to 8 mm, and each battery 116a, 116b is spaced apart from each adjacent battery 116a, 116b to facilitate airflow between the batteries, for instance by an air gap of approximately 5 mm to 8 mm.

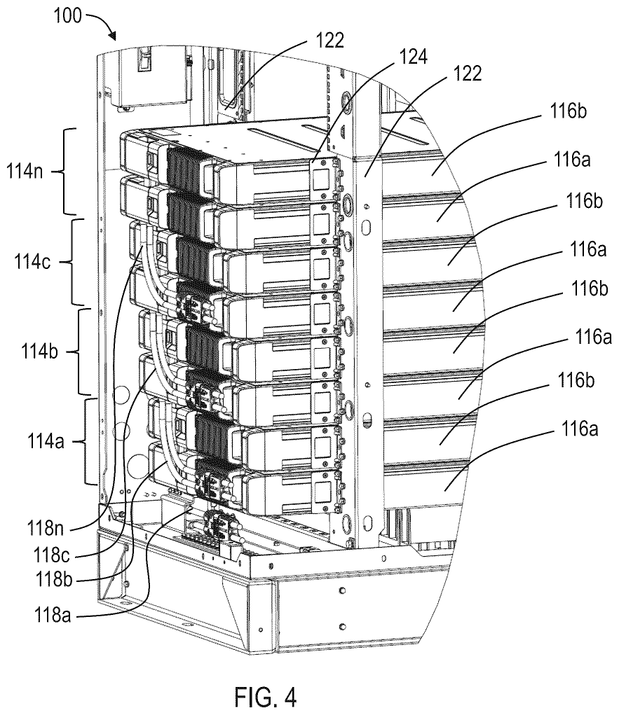

FIG. 4 illustrates battery mounting in the enclosure 100. In embodiments, the enclosure includes vertical frame elements 122 and each battery 116a, 116b includes mounting ears 124 positioned on opposing lateral sides of the battery for attaching to the vertical frame elements 122, for instance using fasteners. As shown, the batteries 116a, 116b are mounted vertically equidistant and closely spaced. Each battery cable 118a, 118b, 118c, 118n is routed to its respective battery set 114a, 114b, 114c, 114n. In embodiments, the first battery cable 118a is coupled to the first battery set 114a and is routed laterally in the space formed below the first battery set 114a, the second battery cable 118b is coupled to the second battery set 114b and routed downward and then laterally in the space formed forward of the first battery set 114a, the third battery cable 118c is coupled to the third battery set 114c and is routed downward and then laterally in the space formed forward of the second battery set 114b, the fourth battery cable 118n is coupled to the fourth battery set 114n and is routed downward and then laterally in the space formed forward of the third battery set 114c, and so forth.

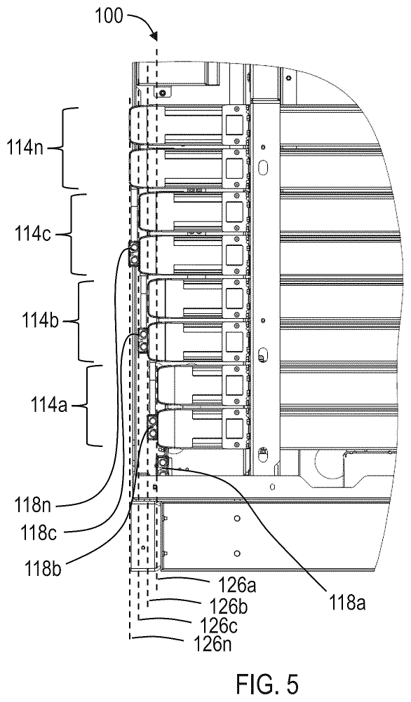

FIG. 5 illustrates the offset positions of the individual battery sets 114a, 114b, 114c, 114n which forms the forward spacing for routing the battery cables 118a, 118b, 118c, 118n. The first battery set 114a is aligned along a first vertical plane 126a. The second battery set 114b is aligned along a second vertical plane 126b positioned forward in the enclosure 100 relative to the first vertical plane 126a. The third battery set 114c is aligned along a third vertical plane 126c positioned forward in the enclosure 100 relative to the second vertical plane 126b. The fourth battery set 114n is aligned along a fourth vertical plane 126n positioned forward in the enclosure 100 relative to the third vertical plane 126c. The vertical alignment may pertain to the batteries themselves and/or the positive and negative battery cable termination posts on the batteries. In addition, vertical is intended to include vertical, approximately vertical, and generally upright.

By recessing the third battery set 114c relative to the fourth battery set 114n, recessing the second battery set 114b relative to the third battery set 114c, and recessing the first battery set 114a relative to the second battery set 114b, the battery sets are positioned to form an inverse stairstep pattern whereby space is formed forward of one battery set for routing the battery cable of the battery set positioned immediately above, with the exception of the routing of the first battery cable 118a which is routed in the space below the first battery set 114a. In a non-limiting example, the distance between the vertical planes 126a, 126b, 126c, 126n may be equidistant and about 18 mm to 22 mm to accommodate 2/0 AWG cabling equipped with a battery cable disconnect. The spacing between battery sets and spacing within the enclosure 100 may depend on the dimensions of the enclosure, dimensions of the interior space, configuration of the batteries, configuration of the positive and negative battery cable termination posts, configuration of the door of the enclosure 100, type of battery cable used, etc.

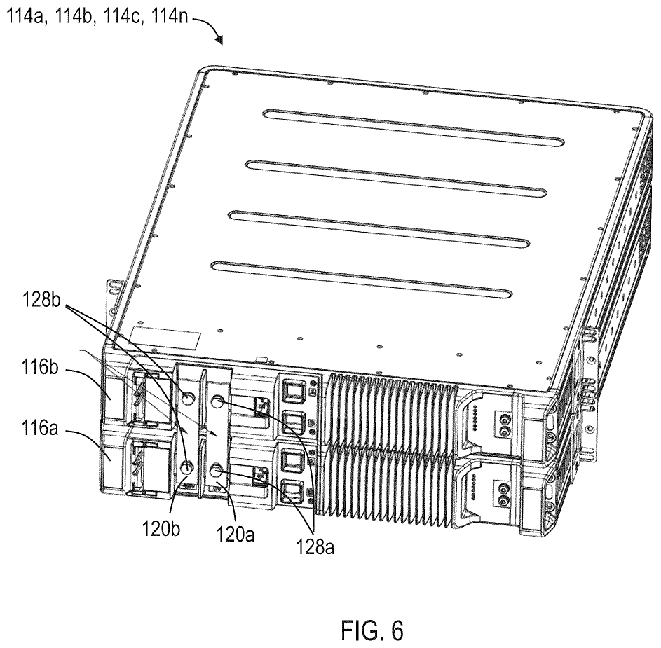

FIG. 6 illustrates a non-limiting example of a battery set 114a, 114b, 114c, 114n that includes two 180 AMP hour Li-Ion batteries 116a, 116b. Each battery 116a, 116b includes a positive battery cable termination post 128a and a negative battery cable termination post 128b presented at the front of the battery. Within each battery set, the positive battery cable termination posts 128a are vertically aligned and coupled via a positive conductive busbar 120a, and the negative battery cable termination posts 128b are coupled via a negative conductive busbar 120b such that a single battery cable can serve each battery set. As shown, the positive and negative busbars 120a, 120b are substantially linear for use with the second, third and additional battery sets 114b, 114c, 114n to facilitate initial downward routing of the associated battery cable. The shape, type and capacity of the battery may vary depending on application.

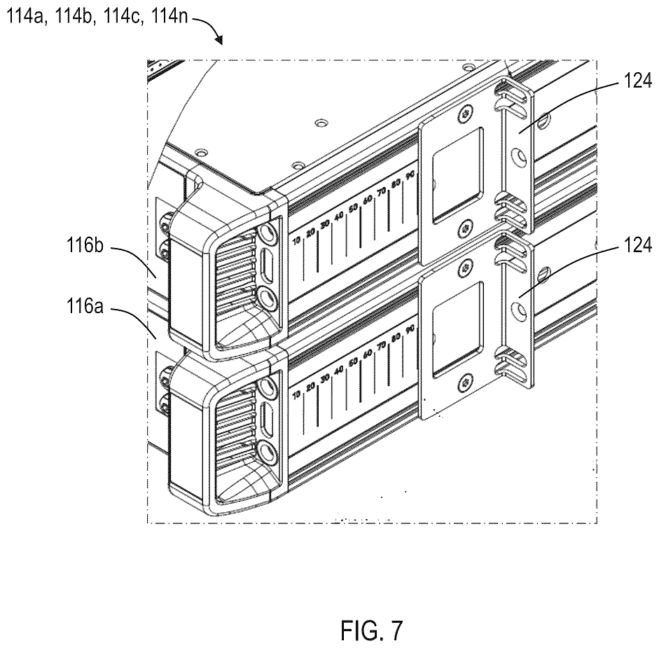

FIG. 7 illustrates a non-limiting battery set configuration wherein each battery 116a, 116b includes repositionable mounting ears 124 for adjusting the depth of the battery sets 114a, 114b, 114c, 114n within the enclosure. In embodiments, each mounting ear 124 is positionable along the longitudinal length of the battery casing such that depth can be set different for each of the first, second, third and additional battery sets 114a, 114b, 114c, 114n. As shown, the mounting ears 124 are angled to provide a first portion positioned against the battery casing and a second portion for positioning against the enclosure such that each battery 116a, 116b can be mounted substantially horizontally in the enclosure.

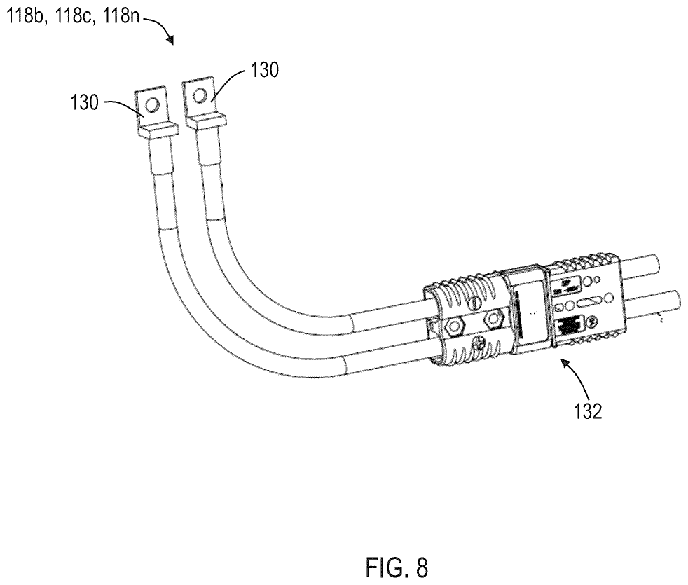

FIG. 8 illustrates a non-limiting example of a battery cable 118b, 118c, 118n for use with the second, third and additional battery sets 114b, 114c, 114n. The battery cable 181b, 118c, 118n includes the wires for the positive and negative connections on the battery cable side that terminate in connectors 130 for attachment to the positive and negative busbars. In embodiments, the battery cable 118b, 118c, 118n includes a battery cable disconnect 132 for disconnecting the battery side from the power system side. As shown, the battery cable 118b, 118c, 118n is configured to be routed downward and then laterally.

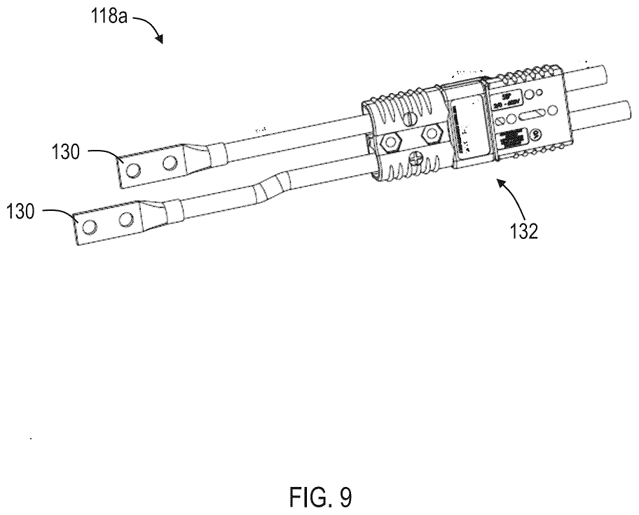

FIG. 9 illustrates a non-limiting example of a battery cable 118a for use with the first battery set 118a. The battery cable 118a includes the wires for the positive and negative connections on the battery cable side that terminate in connectors 130 for attachment to the positive and negative busbars. In embodiments, the battery cable 118a includes a battery cable disconnect 132 for disconnecting the battery side from the power system side. As shown, the battery cable 118a is configured to be routed laterally. In some embodiments, the length of the wires on the battery side may be different to account for the distance to the positive and negative busbars. For example, the wire for connection to the positive busbar may be shorter than the wire for connection to the negative busbar, and vice versa.

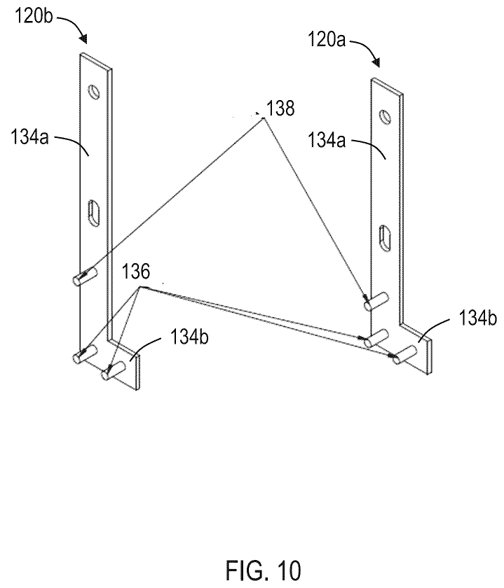

FIG. 10 illustrates non-limiting examples of the positive busbar 120a and the negative busbar 120b for use with the first battery set 114a. In embodiments, each busbar 120a, 120b includes a first portion 134a and a second portion 134b angled relative to the first portion 134a. As shown, the second portion 134b is perpendicular to the first portion 134a such that the first portion 134a extends vertically downward from the first battery set 114a and the second portion 134b extends laterally to direct the attached battery cable 118a straight and in the lateral direction. In some embodiment, the first portion 134a of the negative busbar 120b may have a longer length than the first portion 134a of the positive busbar 120a, or vice versa, such that the battery cable routes can be made parallel for direction lateral routing. In embodiments, each busbar 120a, 120b includes battery cable mounting studs 136 and at least one cover mounting stud 138.

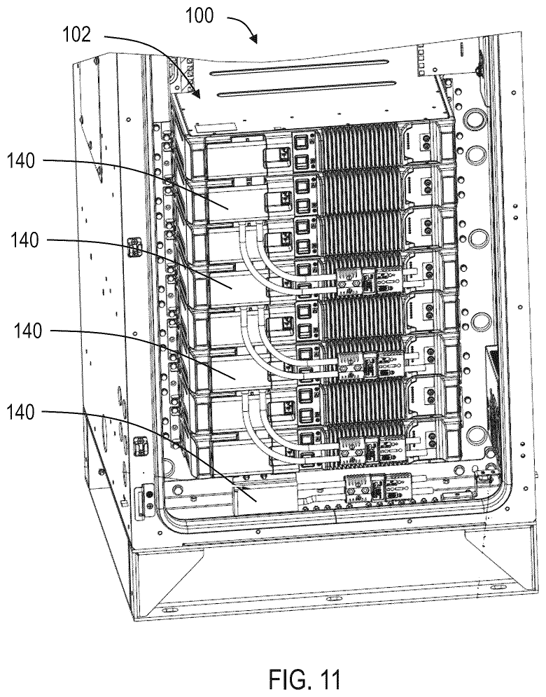

FIG. 11 illustrates the complete battery stack 102 mounted in the enclosure 100, and with protective covers 140 installed over the battery cable to busbar connections. Each battery cable is shown routed, organized, and accessible through the front opening of the enclosure, and with the battery disconnects conveniently positioned for use.

In a particular conceived example, the enclosure 100 may have a total of 36 RU of space available, and the power system for the enclosure 100 may be a 300 Amp system requiring 6 RU of equipment rack space. With a 300 Amp power system, eight 180 Amp hour Li-Ion Batteries may be used to effectively distribute the current draw required from the 300 Amp power system without experiencing premature thermal shutdown prior to reaching capacity. The Li-Ion batteries may be dimensioned approximately 55 cm wide×72 cm deep and 2 RU tall. The spacing between batteries may be a minimum of 5 mm to assure proper airflow. Thus, eight 180 Amp hour Li-Ion batteries per the above can physically fit within 17 RU of equipment rack space leaving 13 RU of equipment rack space available for other critical infrastructure equipment. The battery cable size may be 2/0 AWG. Each battery set may include at least two batteries linked via copper busbars to reduce the number of battery cables. The eight 180 Amp hour Li-Ion batteries may be linked in sets of two requiring four battery sets in total.

From the above description, it is clear that the present disclosure disclosed herein is well adapted to achieve the objectives and to attain the advantages mentioned herein as well as those inherent in the present disclosure disclosed herein. While example embodiments of the present disclosure disclosed herein has been described for purposes of this disclosure, it will be understood that numerous changes may be made which will readily suggest themselves to those skilled in the art and which are accomplished within the broad scope and coverage of the present disclosure disclosed and claimed herein.

What is claimed is:

1. A battery arrangement for a power and battery backup enclosure delimiting an interior space, comprising:
a first battery set mounted in the interior space, the first battery set including at least two batteries having positive and negative battery cable termination posts aligned along a first vertical plane;
a first battery cable electrically coupled to the positive and negative battery termination posts of the at least two batteries of the first battery set;
a second battery set mounted in the enclosure above the first battery set, the second battery set including at least two batteries having positive and negative battery cable termination posts aligned along a second vertical plane positioned forward relative to the first vertical plane; and
a second battery cable electrically coupled to the positive and negative battery cable termination posts of the at least two batteries of the second battery set.

2. The battery arrangement according to claim 1, wherein:
the positive and negative battery cable termination posts of the at least two batteries of the first battery set are positioned along a front of the interior space;
the first battery cable is routed laterally toward one side of the interior space;
the positive and negative battery cable termination posts of the at least two batteries of the second battery set are positioned along the front of the interior space; and
the second battery cable is routed downward and then laterally toward the one side of the interior space.

3. The battery arrangement according to claim 1, wherein:
the first battery set further comprises a first busbar coupled to the positive battery cable termination posts of the at least two batteries and a second busbar coupled to the negative battery cable termination posts of the at least two batteries;
the first battery cable is electrically coupled to the first and second busbars of the first battery set;
the second battery set further comprises a first busbar coupled to the positive battery cable termination posts of the at least two batteries and a second busbar coupled to the negative battery cable termination posts of the at least two batteries; and
the second battery cable is electrically coupled to the first and second busbars of the second battery set.

4. The battery arrangement according to claim 3, wherein:
the first and second busbars of the first battery set are angled; and
the first and second busbars of the second battery set are linear.

5. The battery arrangement according to claim 4, wherein, for the first battery set:
each of the first and second busbars includes a first portion and a second portion perpendicular to the first portion; and
a length of the first portion of the first busbar is greater than a length of the first portion of the second busbar, or vice versa.

6. The battery arrangement according to claim 1, further comprising:
a third battery set mounted in the enclosure above the second battery set, the third battery set including at least two batteries having positive and negative battery cable termination posts aligned along a third vertical plane positioned forward relative to the second vertical plane; and
a third battery cable electrically coupled to the positive and negative battery cable termination posts of the at least two batteries of the third battery set;
wherein:
the positive and negative battery cable termination posts of the at least two batteries of the third battery set are positioned along a front of the interior space; and
the third battery cable is routed downward and then laterally toward one side of the interior space.

7. The battery arrangement according to claim 6, wherein:
the third battery set further comprises a first busbar coupled to the positive battery cable termination posts of the at least two batteries and a second busbar coupled to the negative battery cable termination posts of the at least two batteries;
the third battery cable is electrically coupled to the first and second busbars of the third battery set; and
the first and second busbars of the third battery set are linear.

8. The battery arrangement according to claim 6, further comprising:
a fourth battery set mounted in the enclosure above the third battery set, the fourth battery set including at least two batteries having positive and negative battery cable termination posts aligned along a fourth vertical plane positioned forward relative to the third vertical plane; and
a fourth battery cable electrically coupled to the positive and negative battery cable termination posts of the at least two batteries of the fourth battery set;
wherein:
the positive and negative battery cable termination posts of the at least two batteries of the fourth battery set are positioned along a front of the interior space; and
the fourth battery cable is routed downward and then laterally toward one side of the interior space.

9. The battery arrangement according to claim 8, wherein:
the fourth battery set further comprises a first busbar coupled to the positive battery cable termination posts of the at least two batteries and a second busbar coupled to the negative battery cable termination posts of the at least two batteries;
the fourth battery cable is electrically coupled to the first and second busbars of the fourth battery set; and
the first and second busbars of the fourth battery set are linear.

10. An outside plant enclosure, comprising:
a housing delimiting an interior space accessible through a front of the enclosure, the interior space including an upper portion for mounting electronic equipment and a lower portion; and
a battery stack mounted in the lower portion, the battery stack comprising:
a first battery set including at least two batteries having positive and negative battery cable termination posts aligned at the front of the enclosure along a first vertical plane;
a first battery cable electrically coupled to the positive and negative battery cable termination posts of the at least two batteries of the first battery set;
a second battery set mounted above the first battery set and including at least two batteries having positive and negative battery cable termination posts aligned at the front of the enclosure along a second vertical plane positioned forward relative to the first vertical plane; and
a second battery cable electrically coupled to the positive and negative battery cable termination posts of the at least two batteries of the second battery set.

11. The outside plant enclosure according to claim 10, wherein:
the first battery cable is routed laterally toward one side of the interior space; and
the second battery cable is routed downward and then laterally toward the one side of the interior space.

12. The outside plant enclosure according to claim 10, wherein:
the first battery set further comprises a first busbar coupled to the positive battery cable termination posts of the at least two batteries and a second busbar coupled to the negative battery cable termination posts of the at least two batteries;
the first battery cable is electrically coupled to the first and second busbars of the first battery set;
the second battery set further comprises a first busbar coupled to the positive battery cable termination posts of the at least two batteries and a second busbar coupled to the negative battery cable termination posts of the at least two batteries;
the second battery cable is electrically coupled to the first and second busbars of the second battery set;
the first and second busbars of the first battery set are angled; and
the first and second busbars of the second battery set are linear.

13. The outside plant enclosure according to claim 12, wherein, for the first battery set:
each of the first and second busbars includes a first portion and a second portion perpendicular to the first portion; and
a length of the first portion of the first busbar is greater than a length of the first portion of the second busbar, or vice versa.

14. The outside plant enclosure according to claim 10, wherein the battery stack further comprises:
a third battery set mounted above the second battery set and including at least two batteries having positive and negative battery cable termination posts aligned at the front of the enclosure along a third vertical plane positioned forward relative to the second vertical plane; and
a third battery cable electrically coupled to the positive and negative battery cable termination posts of the at least two batteries of the third battery set;
wherein the third battery cable is routed downward and then laterally toward one side of the interior space.

15. The outside plant enclosure according to claim 14, wherein:
the third battery set further comprises a first busbar coupled to the positive battery cable termination posts of the at least two batteries and a second busbar coupled to the negative battery cable termination posts of the at least two batteries;
the third battery cable is electrically coupled to the first and second busbars of the third battery set; and
the first and second busbars of the third battery set are linear.

16. A battery stack configured to be mounted in an interior space delimited by an enclosure, comprising:
a first battery set including at least two batteries each having positive and negative battery cable termination posts aligned along a first vertical plane;
a second battery set mounted above the first battery set and including at least two batteries each having positive and negative battery cable termination posts aligned along a second vertical plane positioned forward of the first vertical plane;
at least one additional battery set mounted above the second battery set and including at least two batteries each having positive and negative battery cable termination posts aligned along a vertical plane positioned forward of the vertical plane of the respective battery set positioned immediately below;
a first battery cable electrically connected to the positive and negative battery cable termination posts of the first battery set, the first battery cable routed laterally;
a second battery cable electrically connected to the positive and negative battery cable termination posts of the second battery set, the second battery cable routed downward and then laterally; and
at least one additional battery cable, each at least one additional battery cable electrically connected to one of the additional battery sets and routed downward and then laterally.

17. The battery stack according to claim 16, wherein the first battery set, the second battery set, and the at least one additional battery set are arranged in an inverse staircase pattern such that the first battery set is recessed relative to the second battery set, and the second battery set is recessed relative to the at least one additional battery set.

18. The battery stack according to claim 16, wherein:
the first battery set further comprises a first busbar coupled to the positive battery cable termination posts of the at least two batteries and a second busbar coupled to the negative battery cable termination posts of the at least two batteries;
the first battery cable is electrically coupled to the first and second busbars of the first battery set;
the second battery set and the at least one additional battery set further comprises a first busbar coupled to the positive battery cable termination posts of the at least two batteries and a second busbar coupled to the negative battery cable termination posts of the at least two batteries;
the second battery cable and the at least one additional battery cable are electrically coupled to the first and second busbars of the second battery set and the first and second busbars of the at least one additional battery set, respectively;
the first and second busbars of the first battery set are angled; and
the first and second busbars of the second battery set and the at least one additional battery set are linear.

19. The battery stack according to claim 18, wherein, for the first battery set:
each of the first and second busbars includes a first portion and a second portion perpendicular to the first portion; and
a length of the first portion of the first busbar is greater than a length of the first portion of the second busbar, or vice versa.

20. The battery stack according to claim 16, wherein each of the first battery cable, the second battery cable, and the at least one additional battery cable includes a disconnect connector.
